(19) United States
(12) Patent Application Publication
(10) Pub. No.: US 2025/0024896 A1
(43) Pub. Date: Jan. 23, 2025

(54) CHARGING DEVICE HAVING AN ANTENNA

(71) Applicant: NICOVENTURES TRADING LIMITED, London (GB)

(72) Inventors: Mohammed AL-AMIN, London (GB); Connor BRUTON, London (GB); Damyn MUSGRAVE, London (GB)

(21) Appl. No.: 18/717,875

(22) PCT Filed: Dec. 8, 2022
(86) PCT No.: PCT/GB2022/053132

§ 371 Date: Jun. 7, 2024

(30) Foreign Application Priority Data
Dec. 9, 2021 (GB) 2117814.0

(51) Int. Cl. A24F 40/95; A24F 40/65; H02J 7/00

(52) U.S. Cl. CPC A24F 40/95; A24F 40/65; H02J 7/00034; H02J 7/0044

(57) ABSTRACT

An aerosol provision device is described comprising: a battery; an antenna for receiving radio frequency signals and a charging controller configured to charge the battery with power extracted from the received radio frequency signals. The antenna is extendable so as to increase an exposed surface area of the antenna. A case is also described comprising means for electrically coupling the case to the aerosol provision device; an antenna for receiving radio frequency signals; and a charging controller configured to charge a battery of the aerosol provision device and/or the case with power extracted from the received radio frequency signals.

### TECHNICAL FIELD

The present specification relates to battery charging, for example to charging a battery of an aerosol provision device or a case for an aerosol provision device.

### BACKGROUND

Smoking articles, such as cigarettes, cigars and the like burn tobacco during use to create tobacco smoke. Attempts have been made to provide alternatives to these articles by creating products that release compounds without combusting. For example, tobacco heating devices heat an aerosol provision substrate such as tobacco to form an aerosol by heating, but not burning, the substrate. An aerosol provision device may be provided with a case, such as a carry case, for retaining the device when not in use. There remains a need for further developments in this field.

### SUMMARY

In a first aspect, this specification describes an aerosol provision device comprising: a battery; an antenna for receiving radio frequency signals, wherein the antenna is configured to be extendable so as to increase an exposed surface area of the antenna; and a charging controller configured to charge the battery with power extracted from the received radio frequency signals. The antenna may be configured to transmit and/or receive data (e.g. using one of various wireless protocols, such as Bluetooth, Wi-Fi etc.).

The antenna may comprise a folding mechanism such that at least a section of the antenna is extendable. Alternatively, or in addition, the antenna may comprise a telescopic mechanism such that at least a section of the antenna is telescopically extendable. Alternatively, or in addition, the antenna may comprise a scrolled metal sheet (e.g. comprising a scrolled sheet with metal traces); and means for releasing the scrolled metal sheet such that the scrolled metal sheet is extendable.

The antenna may be formed from at least part (e.g. all) of a metal casing of the aerosol provision device.

In a second aspect, this specification describes an aerosol provision device comprising: a battery; a housing; antenna circuitry for receiving radio frequency signals, wherein the antenna circuitry is coupled to the housing such that the housing acts as an antenna; and a charging controller configured to charge the battery with power extracted from the received radio frequency signals. The antenna may thereby have an exposed surface area greater than would otherwise be the case. The antenna may be configured to transmit and/or receive data (e.g. using one of various wireless protocols, such as Bluetooth, Wi-Fi etc.).

In a third aspect, this specification describes a case (e.g. a carry case or a charging case) for an aerosol provision device comprising: means for electrically coupling the case to the aerosol provision device; an antenna for receiving radio frequency signals; and a charging controller configured to charge a battery of the aerosol provision device and/or the case with power extracted from the received radio frequency signals. The antenna may be configured to transmit and/or receive data (e.g. using one of various wireless protocols, such as Bluetooth, Wi-Fi etc.). The antenna may be formed from at least part of (e.g. all of) a metal casing of the case.

The antenna may be configured to be extendable so as to increase an exposed surface area of the antenna. The antenna may comprise a folding mechanism such that at least a section of the antenna is extendable. Alternatively, or in addition, the antenna may comprise a telescopic mechanism such that at least a section of antenna is telescopically extendable. Alternatively, or in addition, the antenna may comprise a scrolled metal sheet (e.g. comprising a scrolled sheet with metal traces); and means for releasing the scrolled metal sheet such that the scrolled metal sheet is extendable.

In some example embodiments, the charging controller charges the battery of the aerosol provision device directly with power extracted from received radio frequency signals.

The case may comprise a battery, wherein the charging controller is configured to charge the battery of the case with power extracted from the received radio frequency signals. The charging controller may be configured to charge the battery of the aerosol provision device with power stored in the battery of the case.

In some example embodiments, the means for electrically coupling the case to the aerosol provision device comprises a physical electrical connection.

In some example embodiments, the means for electrically coupling the case to the aerosol provision device comprises an inductive coupling.

### BRIEF DESCRIPTION OF THE DRAWINGS

Example embodiments will now be described, by way of example only, with reference to the following schematic drawings, in which:

FIG. 1 is a block diagram of a non-combustible aerosol provision device in accordance with an example embodiment;

FIG. 2 is a block diagram of a system in accordance with an example embodiment;

FIG. 3 is an end view of a non-combustible aerosol provision device in accordance with an example embodiment;

FIG. 4 is an illustration of a non-combustible aerosol provision device in accordance with an example embodiment;

FIG. 5 is an illustration of a non-combustible aerosol provision device in accordance with an example embodiment;

FIG. 6 is an end view of a non-combustible aerosol provision device in accordance with an example embodiment;

FIG. 7 shows a case for an aerosol delivery device in accordance with an example embodiment;

FIG. 8 is a block diagram of a system in accordance with an example embodiment;

FIG. 9 is a flow chart showing a use of the system of FIG. 8 in accordance with an example embodiment;

FIGS. 10 to 12 are views from above of cases for an aerosol delivery device in accordance with example embodiments; and

FIGS. 13 and 14 are views from above of the inside of cases for an aerosol delivery device in accordance with example embodiments.

### DETAILED DESCRIPTION

As used herein, the term “delivery system” is intended to encompass systems that deliver at least one substance to a user, and includes non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

According to the present disclosure, a “combustible” aerosol provision system is one where a constituent aerosol-generating material of the aerosol provision system (or component thereof) is combusted or burned during use in order to facilitate delivery of at least one substance to a user.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered may be an aerosol-generating material or a material that is not intended to be aerosolised. As appropriate, either material may comprise one or more active constituents, one or more flavours, one or more aerosol-former materials, and/or one or more other functional materials.

In some embodiments, the substance to be delivered comprises an active substance. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. In one embodiment, the active substance is a legally permissible recreational drug. In some embodiments, the active substance comprises nicotine. In some embodiments, the active substance comprises caffeine, melatonin or vitamin B12. In some embodiments, the active substance comprises or is derived from one or more botanicals or constituents, derivatives or extracts thereof and the botanical is tobacco. In some embodiments, the substance to be delivered comprises a flavour.

Aerosol-generating material is a material that is capable of generating aerosol, for example when heated, irradiated or energized in any other way. Aerosol-generating material may, for example, be in the form of a solid, liquid or gel which may or may not contain an active substance and/or flavourants.

The aerosol-generating material may be an “amorphous solid”. In some embodiments, the amorphous solid is a “monolithic solid”. The aerosol-generating material may be non-fibrous or fibrous. In some embodiments, the aerosol-generating material may be a dried gel. The aerosol-generating material may be a solid material that may retain some fluid, such as liquid, within it. In some embodiments the retained fluid may be water (such as water absorbed from the surroundings of the aerosol-generating material) or the retained fluid may be solvent (such as when the aerosol-generating material is formed from a slurry). In some embodiments, the solvent may be water.

In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavours, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

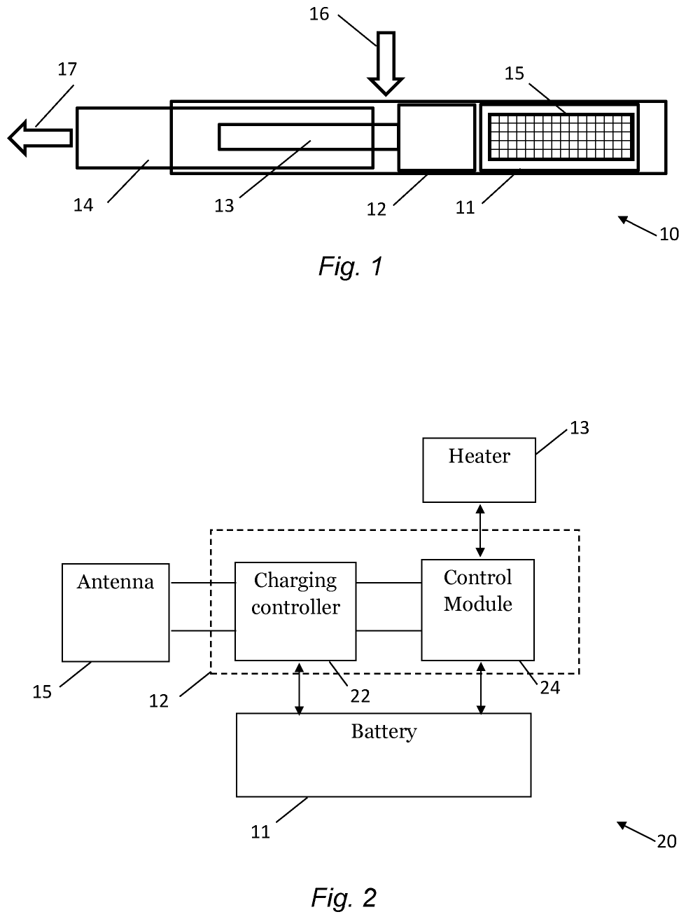

FIG. 1 is a block diagram of a non-combustible aerosol provision device, indicated generally by the reference numeral 10, in accordance with an example embodiment.

The aerosol provision device 10 comprises a battery 11, a control circuit 12, a heater 13 and a consumable 14 (e.g. a tobacco consumable, for example in the form of a tobacco stick). The device also includes an antenna 15. The example antenna 15 is shown provided near the battery 11; however, this is one of many example locations. As discussed in detail below, the antenna may be used to receive radio frequency signals for use in charging the battery 11 (e.g. under the control of the control circuit 12). In addition, the antenna 15 may be used to transmit and/or receive data, for example using one of a number of protocols (e.g. Bluetooth, Wi-Fi etc.).

In the use of the device 10, the heater 13 is inserted into the consumable 14, such that the consumable may be heated to generate an aerosol (and tobacco flavour, in the case of a tobacco consumable) for the user. When a user inhales at the end of the consumable, as indicated by arrow 17, the air is drawn into the device 10, through an air inlet as indicated by arrow 16, then passes through the consumable, delivering the aerosol (and tobacco flavour, in the case of a tobacco consumable) to the user.

The aerosol provision device 10 is described by way of example only. Many alternative aerosol provision devices may be used in example implementations of the principles described here. For example, the device 10 may be replaced within a vaping device in which an aerosol generating material (e.g. a liquid) is heated to generate the aerosol. The principles of the present disclosure are not limited to a particular type of aerosol provision device 10 (that is to say, the aerosol provision device 10 may be arranged to aerosolise a solid, liquid or other aerosol-generating material via any suitable electrically powered or controller aerosol generator, such as a heater, a vibrating mesh, a source of irradiation, an electrically controller pressurised cannister which may include an electrically operated release valve, etc.).

FIG. 2 is a block diagram of a system, indicated generally by the reference numeral 20, in accordance with an example embodiment.

The system 20 comprises the battery 11, the control circuit 12, the heater 13 (or more generally, the aerosol generator) and the antenna 15 of the aerosol provision device 10 described above. The control circuit 12 of the system 20 comprises a charging controller 22 and a control module 24.

The antenna 15 may be used to receive radio frequency signals for use in charging the battery 11 (e.g. under the control of the control circuit 12). Furthermore, the charging controller 22 may be configured to charge the battery 11 (e.g. under the control of the control module 24) with power extracted from the received radio frequency signals.

The antenna 15 may be used to extract electrical power may be extracted from radio frequency (RF) signals. This may be implemented in a number of ways. For example, the receipt of RF signals by the antenna 15 may cause a potential difference to occur across the length of the antenna. Thus, an AC (typically sinusoidal) RF signal can be obtained at the antenna. This AC signal is typically converted into a DC signal, for example using a rectifier circuit (such as a full bridge or half-bridge rectifier circuit). In some example embodiments, an impedance matching circuit is provided between the antenna and a rectifier circuit that seeks to maximise power transfer from the antenna to the rectifier. The DC electrical power output by the rectifier may, for example, be stored using the battery 11.

It should be noted that, in some example embodiments, the functionality of the control module 24 is implemented by the charging controller 22. Indeed, the control module 24 may be omitted from some example embodiments.

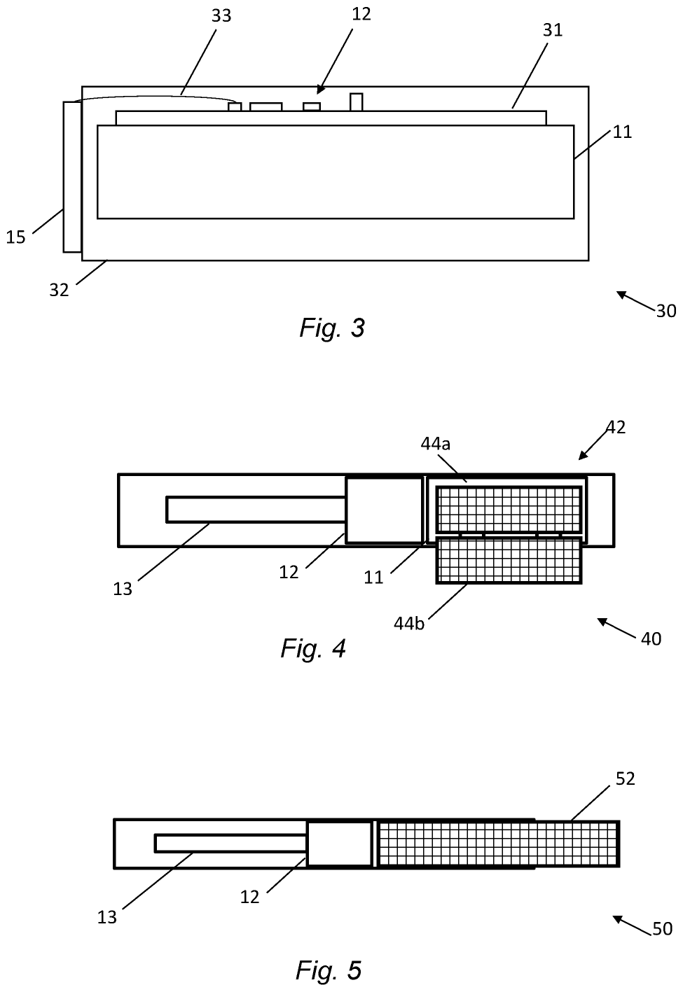

FIG. 3 is an end view of a non-combustible aerosol provision device, indicated generally by the reference numeral 30, in accordance with an example embodiment. The device 30 is shown with a cap removed such that the battery 11 is visible. Also shown is the antenna 15 and a printed circuit board 31 on which the control circuit 12 is provided. An electrical connection 33 between the control circuit 12 and the antenna 15 is shown schematically in FIG. 3.

As shown in FIG. 3, the printed circuit board 31 and the battery 11 are mounted within a housing 32 of the device 30. Note that although the battery 11 is shown below the printed circuit board 31, this is just one example implementation. The printed circuit board and the battery may, for example, be provided side-by-side.

As discussed further below, the antenna 15 may be extendable so as to increase an exposed surface area of the antenna. The exposed surface area of the antenna typically includes any surface areas of the antenna that are firstly configured to interact with radio frequency radiation and secondly are not overlapped in a direction substantially normal to the surface of the antenna by material capable of interacting with the radio frequency radiation (including any other surfaces/surface areas of the antenna).

Many configurations of extendable antenna are possible, some of which are described below by way of example.

FIG. 4 is an illustration of a non-combustible aerosol provision device, indicated generally by the reference numeral 40, in accordance with an example embodiment.

The aerosol provision device 40 comprises the battery 11, the control circuit 12 and the heater 13 of the aerosol provision device 10 described above. The consumable 14 is omitted. The device 40 also includes an antenna 42. The antenna 42 is extendable such that the exposed surface area of the antenna can be increased. In the configuration shown in FIG. 4, the antenna 42 is unfolded such that a first portion 44a and a second portion 44b of the antenna are both visible and available to receive radio frequency signals. Thus, in the device 40, the unfolded antenna has a larger surface area in a given plane than when the antenna is folded (i.e. the unfolded antenna is extended in said plane compared with the folded antenna). Note that, in common with the antenna 15, the antenna 42 may be used to transmit and/or receive data, for example using one of a number of protocols (e.g. Bluetooth, Wi-Fi etc.).

FIG. 5 is an illustration of a non-combustible aerosol provision device, indicated generally by the reference numeral 50, in accordance with an example embodiment.

The aerosol provision device 50 comprises the battery 11 and the control circuit 12 and the heater 13 of the aerosol provision devices 10 and 40 described above (although the battery 11 is not visible in FIG. 5). The consumable 14 is omitted. The device 50 also includes an antenna 52. The antenna 52 is extendable such that the exposed surface area of the antenna can be increased. In the configuration shown in FIG. 5, the antenna 52 is shown in an extended position.

The antenna 52 may be telescopically extendable. Alternatively, the antenna 52 may comprise a scrolled metal sheet (e.g. a scrolled sheet with metal traces) and means for releasing the scrolled metal sheet such that the scrolled metal sheet is extendable.

As noted above, the exposed surface area of the antennas 42 and 52 typically include any surface areas of the antenna that are firstly configured to interact with radio frequency radiation and secondly are not overlapped in a direction substantially normal to the surface of the antenna by material capable of interacting with the radio frequency radiation (including any other surfaces/surface areas of the antenna).

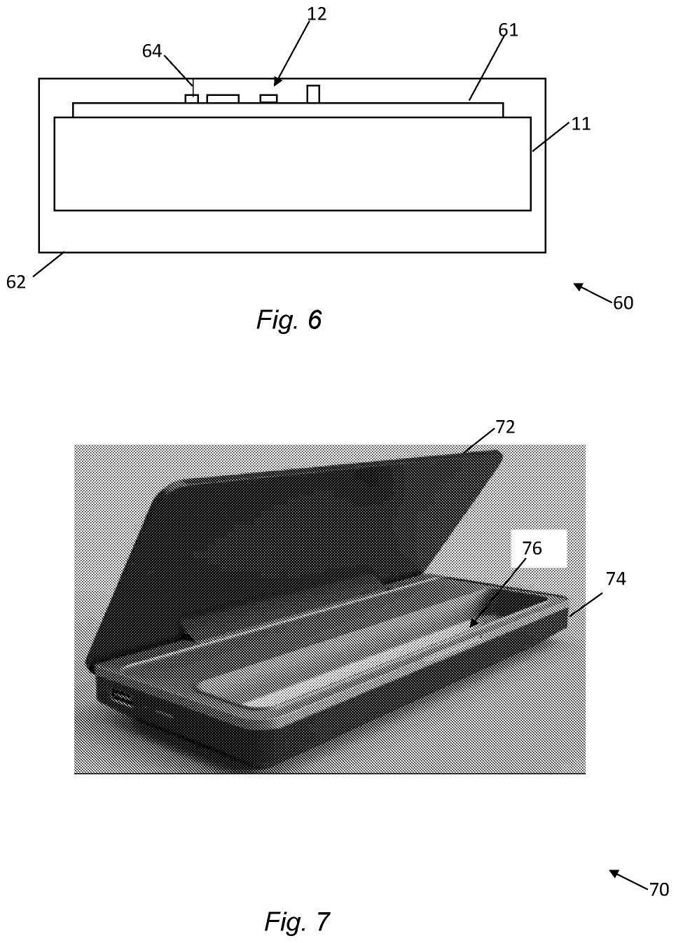

FIG. 6 is an end view of a non-combustible aerosol provision device, indicated generally by the reference numeral 60, in accordance with an example embodiment. The device 60 is similar to the device 30 described above.

The device 60 is shown with a cap removed such that the battery 11 is visible. Also shown is a printed circuit board 61 on which the control circuit 12 is provided.

The device 60 further comprises a metal casing 62. The metal case is used as an antenna (e.g. to provide the functionality of the antenna 15 described above). An electrical connection 64 between the control circuit 12 and the metal casing 62 is shown schematically in FIG. 6. Thus, the entire metal casing can be used as an antenna; note that in some example embodiments, a portion (i.e. not all) of the casing 62 is provided for use as an antenna.

As shown in FIG. 6, the printed circuit board 31 and a battery 11 are mounted within the a housing 32. Note that although the battery 11 is shown below the printed circuit board 31, this is just one example implementation. The printed circuit board and the battery may, for example, be provided side-by-side.

FIG. 7 shows a case for an aerosol delivery device, indicated generally by the reference numeral 70, in accordance with an example embodiment. The case 70 comprises a lid 72 and a main body 74. The main body 74 includes a storage area 76 for storing an aerosol delivery device (not shown in FIG. 7). The aerosol delivery device may be a non-combustible aerosol generating device, although this is not essential to all example embodiments. For example, the case 70 may be configured to receive any of the aerosol delivery devices 10, 30, 40, 50 and 60 described above. It should also be appreciated that the lid 72 is optional and the aerosol provision device may be retained within the case 70 using mechanisms other than the lid 72.

The case 70 may be a carry case, such that the aerosol generating device can be stored within the case. The case 70 may be a charging case, such that a stored aerosol generating device can be charged.

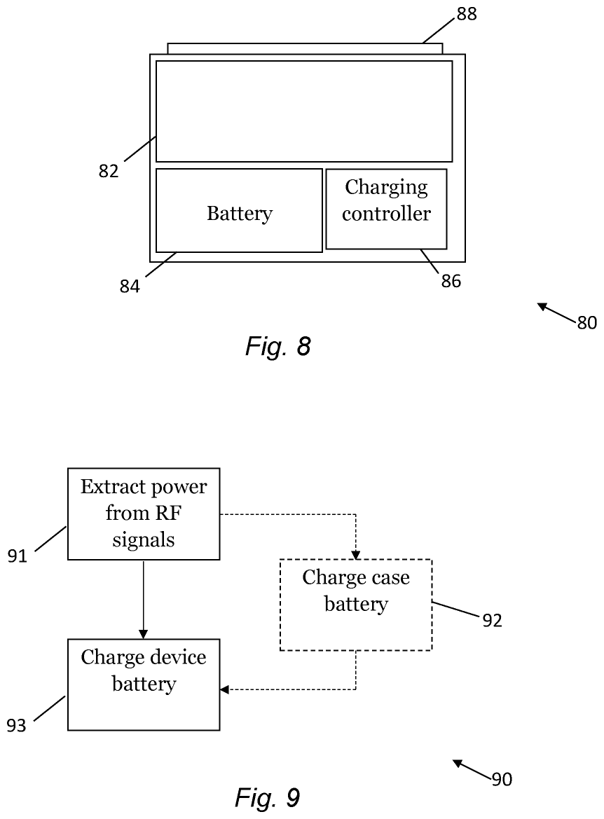

FIG. 8 is a block diagram of a system, indicated generally by the reference numeral 80, in accordance with an example embodiment. The system 80 may form part of the case 70 described above.

The system 80 comprises an area 82 for receiving an aerosol provision device, a charging controller 86 and an antenna 88 for receiving radio frequency signals (and optionally for transmitting and/or receiving data, for example using one of a number of protocols). The system 80 may optionally comprise a battery 84. The area 82 may be the storage area 76 of the case 70 described above. As discussed further below, the charging controller 86 may be configured to charge a battery of the aerosol provision device and/or the battery 84 of the case (if provided) with power extracted from the received radio frequency signals.

The area 82 for receiving the aerosol provision device may include means for electrically coupling to a received aerosol provision device. The said means may take many forms, such as physical electrical connection and/or an inductive coupling.

The antenna 88 may be provided on the exterior of the case (as shown in the system 80), but in some example embodiments, the system 80 may comprise a metal casing which may be used, at least in part, as the antenna. The antenna may be formed from some or all of the metal casing of the case.

FIG. 9 is a high-level schematic flow chart showing a use of the system of FIG. 8 in accordance with an example embodiment.

The algorithm 90 starts at operation 91, where power is extracted from radio frequency signals received by the antenna 88.

Next, operation 92 involves the charging controller 86 controlling the charging of the battery 84 of the case. Note that the operation 92 may be omitted (e.g. if the case does not include the battery 84).

At operation 93, the charging controller 86 controls the charging of the battery of an aerosol provision device received within the area 82 with power extracted from received radio frequency signals received by the antenna 88. For example, the battery of the aerosol provision device may be charged with power stored in the battery 84 or may be charged (under the control of the charging controller 86) directly with power extracted from the received radio frequency signals (without the intervening step of using that power to charge the battery 84).

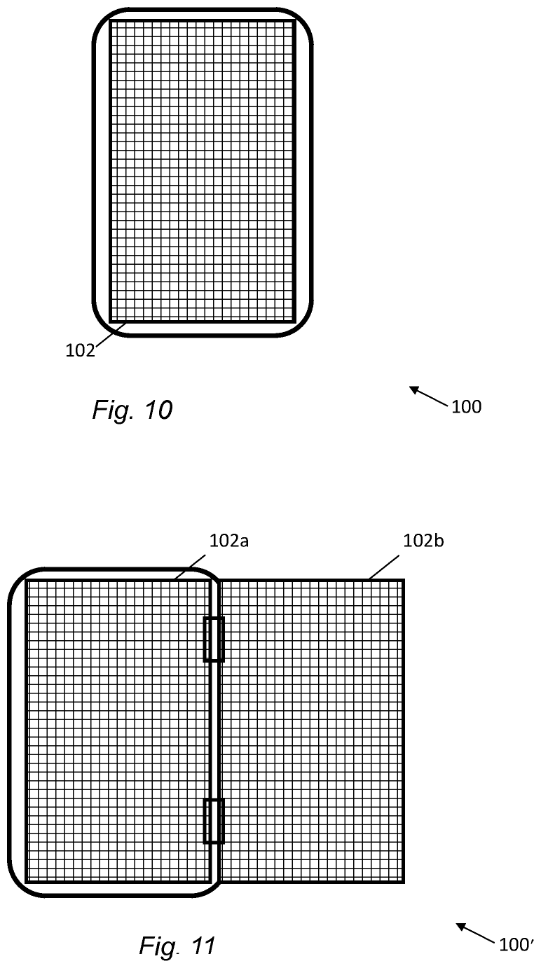

FIGS. 10 to 12 are views from above of a case, indicated generally by the reference numerals 100, 100′, and 100″ respectively, for an aerosol delivery device in accordance with example embodiments. Any of the cases 100, 100′ and 100″ may be the case 70 described above.

The cases 100, 100′ and 100″ includes an antenna 102 on the exterior casing. The antenna 102 is extendable such that the exposed surface area of the antenna can be increased. In the configuration shown in FIG. 10, the antenna 102 is folded. In the configuration shown in FIG. 11, the antenna 102 is unfolded such that a first portion 102a and a second portion 102b of the antenna 102 are both visible and available to receive radio frequency signals. Thus, in the case 100′, the unfolded antenna 102 has a larger surface area in a given plane than when the antenna is folded (i.e. the unfolded antenna is extended in said plane compared with the folded antenna).

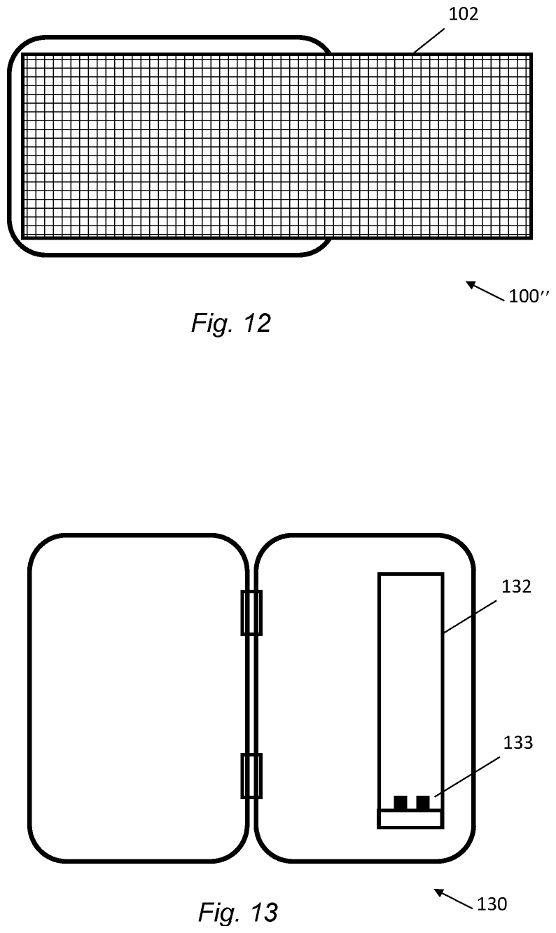

The extendable antenna of the case 100 is one example embodiment of an antenna is that configured to be extendable so as to increase the exposed surface area of the antenna. Other configurations are possible. In the configuration shown in FIG. 12, the antenna 102 is shown in an extended position. The antenna 102 may comprise a telescopic mechanism such that at least a section of antenna is telescopically extendable. Alternatively, the antenna 102 may comprise a scrolled metal sheet (e.g. a scrolled sheet with metal traces) with means for releasing the scrolled metal sheet such that the scrolled metal sheet is extendable. The skilled person will be aware of other extendable configurations that could be used.

FIG. 13 is a view from above of the inside of a case, indicated generally by the reference numeral 130, for an aerosol delivery device, in accordance with example embodiments. The case 130 may be the case 70 described above.

The case 130 may include an aperture 132 configured to fit an aerosol provision device securely. Alternatively, the aperture 132 may be configured such that the aerosol provision device rests in the aperture. The case 130 further comprises physical electrical connectors 133 that can be used to form an electrical connection between the aerosol provision device and the case 130. The aperture 132 may be arranged such that the aerosol provision device fits into the aperture one way, to ensure reliable establishment of an electrical connection.

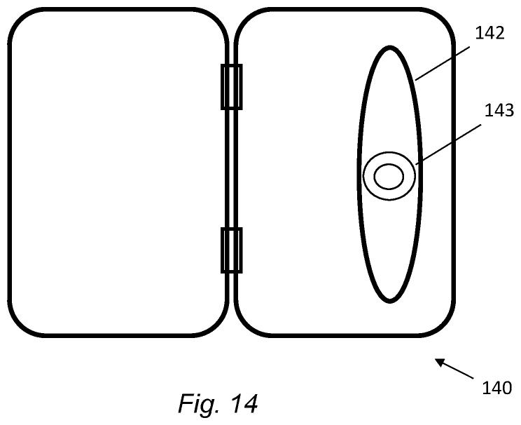

FIG. 14 is a view from above of the inside of a case, indicated generally by the reference numeral 140, for an aerosol delivery device, in accordance with example embodiments. The case 140 may be the case 70 described above.

The case 140 may include an aperture 142 configured to fit an aerosol provision device securely. Alternatively, the aperture 142 may be configured such that the aerosol provision device rests in the aperture. The case 140 further comprises induction module 143 to form an electromagnetic coupling between the aerosol provision device and the case 100. The aperture 142 may be arranged such that the aerosol provision device fits into the aperture such that the induction module 143 aligns with an induction unit of the aerosol provision device.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An aerosol provision device comprising:
a battery;
an antenna for receiving radio frequency signals, wherein the antenna is configured to be extendable so as to increase an exposed surface area of the antenna; and
a charging controller configured to charge the battery with power extracted from the received radio frequency signals.

2. The aerosol provision device as claimed in claim 1, wherein the antenna comprises a folding mechanism such that at least a section of the antenna is extendable.

3. The aerosol provision device as claimed in claim 1, wherein antenna comprises a telescopic mechanism such that at least a section of the antenna is telescopically extendable.

4. The aerosol provision device as claimed in claim 1, wherein the antenna comprises:
a scrolled metal sheet; and
means for releasing the scrolled metal sheet such that the scrolled metal sheet is extendable.

5. The aerosol provision device as claimed in claim 4, wherein the scrolled metal sheet comprises a scrolled sheet with metal traces.

6. The aerosol provision device as claimed in claim 1, wherein the antenna is formed from at least part of a metal casing of the aerosol provision device.

7. An aerosol provision device comprising:
a battery;
a housing;
antenna circuitry for receiving radio frequency signals, wherein the antenna circuitry is coupled to the housing such that the housing acts as an antenna; and
a charging controller configured to charge the battery with power extracted from the received radio frequency signals.

8. A case for an aerosol provision device comprising:
means for electrically coupling the case to the aerosol provision device;
an antenna for receiving radio frequency signals; and
a charging controller configured to charge a battery of the aerosol provision device and/or the case with power extracted from the received radio frequency signals.

9. The case as claimed in claim 8, wherein the antenna is configured to be extendable so as to increase an exposed surface area of the antenna.

10. The case as claimed in claim 9, wherein the antenna comprises a folding mechanism such that at least a section of the antenna is extendable.

11. The case as claimed in claim 9, wherein the antenna comprises a telescopic mechanism such that at least a section of antenna is telescopically extendable.

12. The case as claimed in claim 9, wherein the antenna comprises:
a scrolled metal sheet; and
means for releasing the scrolled metal sheet such that the scrolled metal sheet is extendable.

13. The case as claimed in claim 8, wherein the antenna is formed from at least part of a metal casing of the case.

14. The case as claimed in claim 8, wherein the charging controller charges the battery of the aerosol provision device directly with power extracted from received radio frequency signals.

15. The case as claimed inn claim 8, wherein the case comprises:
a battery,
wherein the charging controller is configured to charge the battery of the case with power extracted from the received radio frequency signals.

16. The case as claimed in claim 15, wherein the charging controller is configured to charge the battery of the aerosol provision device with power stored in the battery of the case.

17. The case as claimed in claim 8, wherein the means for electrically coupling the case to the aerosol provision device comprises a physical electrical connection.

18. The case as claimed in claim 8, wherein the means for electrically coupling the case to the aerosol provision device comprises an inductive coupling.

19. The case as claimed claim 8, wherein the case is a carry case.

20. The aerosol provision device as claimed in claim 1, wherein the antenna is configured to transmit and/or receive data.
